(19) United States
(12) Patent Application Publication
(10) Pub. No.: US 2016/0163296 A1
(43) Pub. Date: Jun. 9, 2016

(54) Fixed key plunger type mechansim(s) for the guitar playing assist apparatus

(71) Applicant: Barry Mark Davis, D'Iberville, MS (US)

(72) Inventor: Barry Mark Davis, D'Iberville, MS (US)

(21) Appl. No.: 14/544,187

(22) Filed: Dec. 8, 2014

(51) Int. Cl. G10G 1/02

(52) U.S. Cl. CPC G10G 1/02

(57) ABSTRACT

A Guitar playing Assist Apparatus is provide with a fixed key plunger type assembly. A thin flat body of clear plastic with a key pad on the inside back base, and a chord scale on the outside front of the base. The chord scale is fitted with braille nodules for guiding the proper placement of the fingers on the base. On the top or upper side, and bottom or lower side of the base are gripping angles for providing a multi chord device. Multiple fixed key plunger type assemblies may provided in lieu of the sliding key lever type mechanisms which can be installed onto or into the base, and which is manipulated by a human hand, or an artificial hand, is pressed and positioned onto the guitar neck, fret and strings to form and sound guitar chords and/or notes.

### RELATED APPLICATIONS

The subject matter of the present application was first described in U.S. Provisional Application Ser. No. 61/963,396, and incorporated by reference as if fully rewritten herein, and includes an improvement of the subject matter described in U.S. Pat. No 7,468,478 for a “GUITAR PLAYING ASSIST APPARATUS” issued to the present inventor.

### BACKGROUND OF THE INVENTION

1. Field of the Invention

This invention relates generally to clear prosthetic/plastic and rubber music chords, and, more specifically to such chords that are used for playing the guitar, specifically a detailed description and operation of additional embodiment from the section of patent in cross-references to related applications, FIG. 6A “dial-a-chord”.

2. Background of the Related Art

Guitar Playing Assist Devices such as the EZ Chord® Apparatus provides a sliding clamp-like structure positioned onto the guitar neck to form and sound guitar chords and note. Also known as the said Handi-Guitar as described in U.S. Pat, No. 7,468,478 provides a similar device for the handicapped guitar player.

The present application provide for a similar guitar playing assistance function with one added feature: the said fixed key plunger type mechanism is utilized in lieu of a slide key lever type mechanism

### BACKGROUND OF THE INVENTION

### Objects and Advantages

The objects and advantages of the present invention are similar as the said Guitar Playing Assist Apparatus also known as the said Handi-Guitar (for the handicapped Guitar Player) as described in U.S. Pat. No. 7,468,478, (the “'478 patent”) with the added features as described.

The preferred embodiment is changed to the said “dial-a-chord” fixed key plunger type mechanism in lieu of the said sliding key lever type mechanism as displayed in the said pioneer patent. The said dial-a-chord fixed key mechanism is the only guitar invention that can produce both “high pitch” and “low pitch” multiple guitar chords. The advantage of the said guitar chord apparatus over other guitar chord devices is its extreme durability to last for the lifetime of the user.

Other guitar chord devices have referenced and utilized the “transparency” of the '478 patent. The major advantage of the present invention is the ability of the user to play over forty (40+) guitar chords with one simple device.

Other guitar inventions are cumbersome and costly. The versatility of the present chord apparatus generates a very wide range of major, minor, sharp and flat guitar chords, far exceeding the advantages of any known guitar chord invention, yet it is fabricated in the simplest form. For people with arm, hand or finger impairments as well as the public in general, the said note and said chord scale is visually appealing to the human sensibilities of sight, touch and sound for the said handicapped guitarist as well as the said public in general. The said fixed key plunger type mechanism of the present invention enables the said public in general an easier method for producing multiple guitar chords. This is engineered to play every major, minor, flat and sharp guitar chord on the rudimentary scale as well as suspension chords, power chords, advanced barre chords and open chords.

### SUMMARY OF THE PRESENT INVENTION

The preferred embodiment of the present invention provides a dial-a-chord fixed key plunger type mechanism.

In accordance with the present invention, the preferred embodiment with the said “fixed key plunger type mechanism” performs the same task and function as said FIG. 6A of the said Guitar Playing Assist Apparatus of the '478 patent's “sliding key lever type mechanism”, by which any chord may be “dialed” to generate multiple guitar chords from one point on the said rudimentary scale to another.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1A is a perspective view of a dial-a-chord “sliding key lever type mechanism” according to a preferred embodiment of the present invention shown in a first chord configuration;

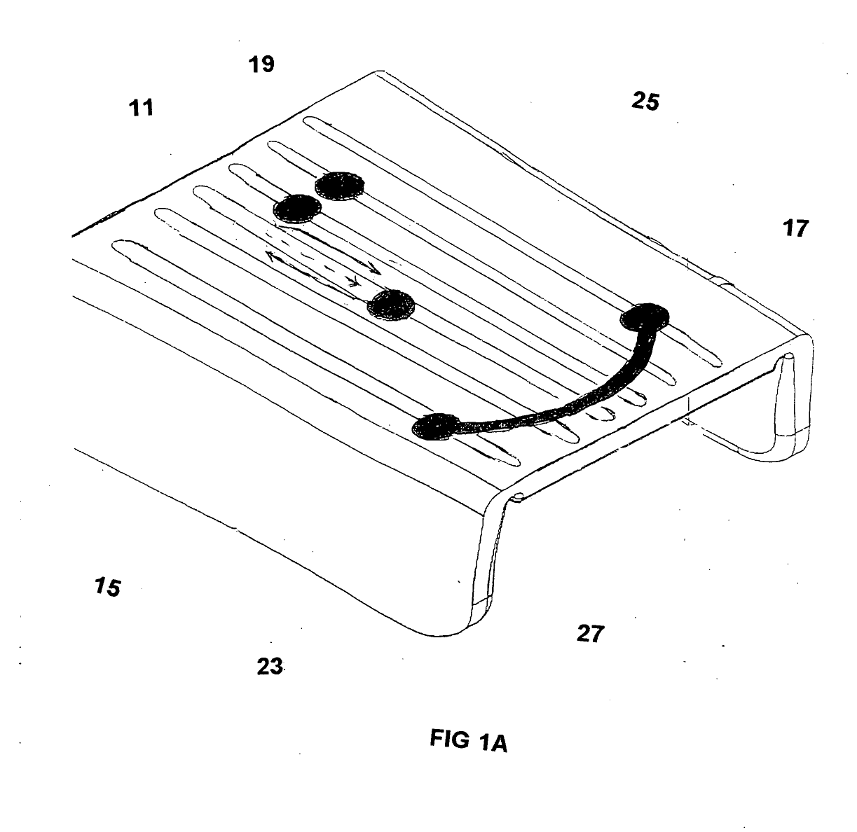

FIG. 1B is a perspective view thereof shown in a second chord configuration;

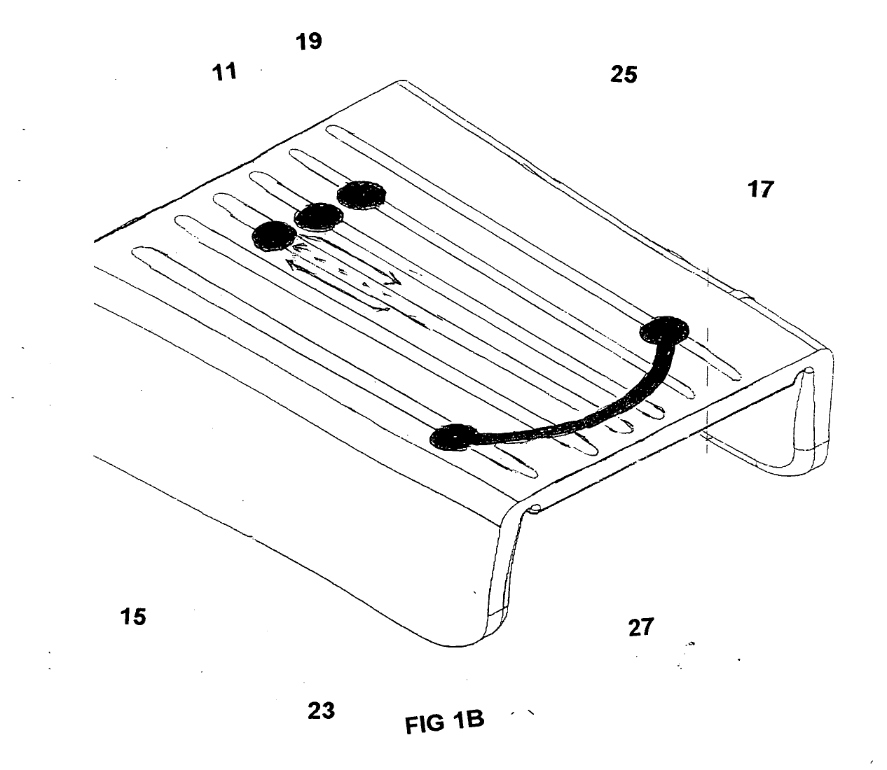

FIG. 1C is a partially exploded perspective view of FIG. 1B;

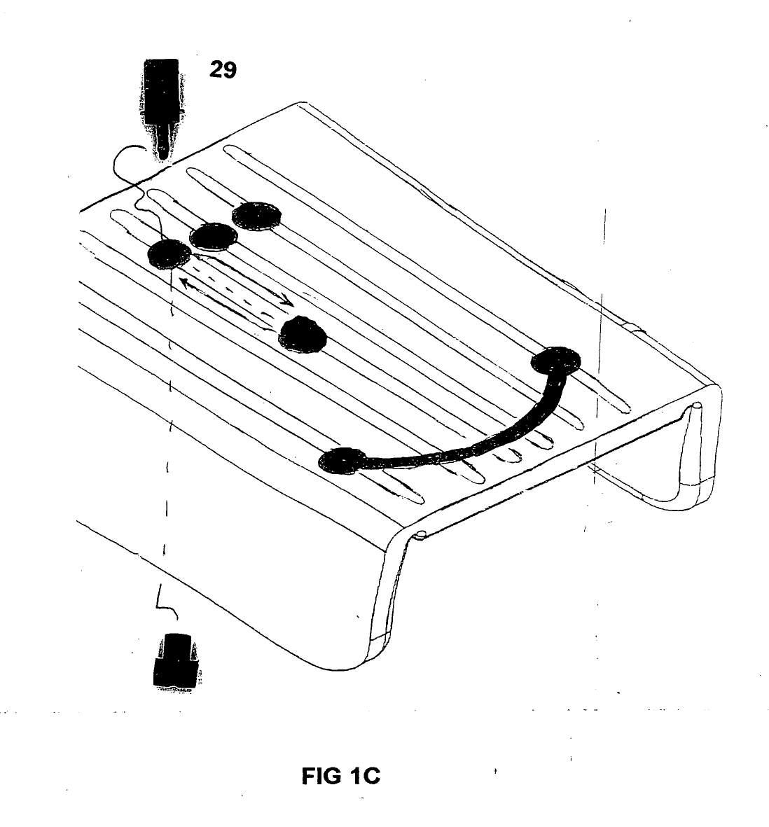

FIG. 1D is a review perspective view thereof;

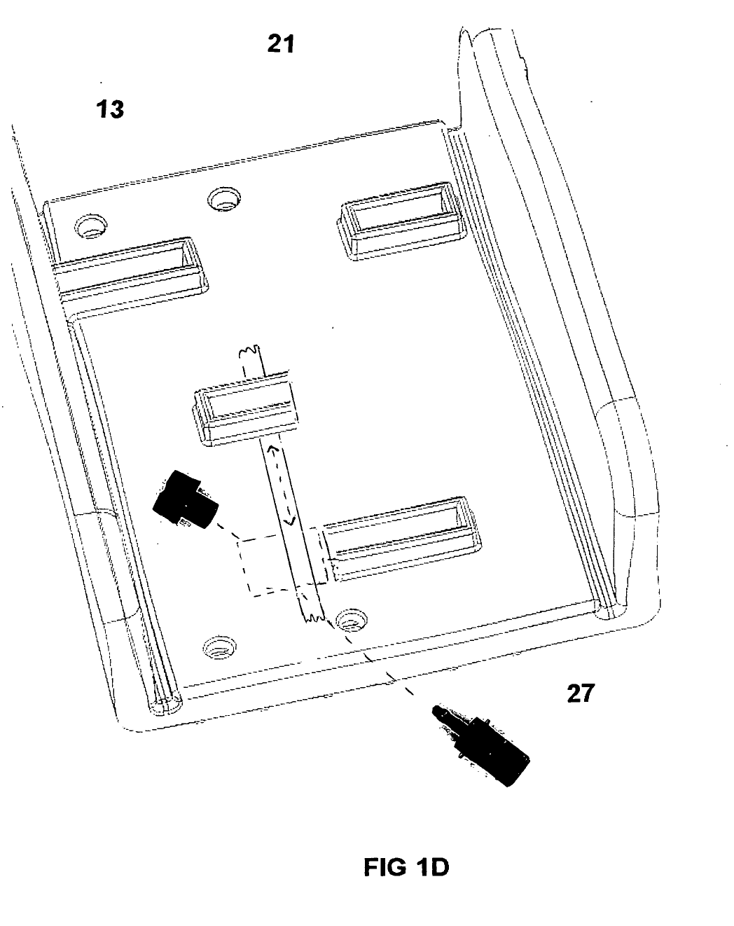

FIG. 2A is a perspective view of a dial-a-chord “fixed key plunger type mechanism” according to a first alternate embodiment of the present invention;

FIG. 2B is a perspective view thereof showing recess indentations for use therewith;

FIG. 2C is a reverse perspective x-ray view of a dial-a-chord fixed key plunger type according to the present invention;

FIG. 2D is a partially exploded view thereof; and

FIG. 2E is a review perspective view thereof.

DRAWING -- REFERENCE NUMBERS

| | |
|---|---|
| 11 | outside front base |
| 13 | inside back base |
| 15 | bottom lower gripping angle |
| 17 | top upper gripping angle |
| 19 | keys |
| 21 | key pad |
| 23 | chord scale |
| 25 | braille nodules |
| 27 | slide groove for dial-a-chord |
| 29 | slide key lever type assembly for the dial- |
| | a-chord |
| 31 | fixed key plunger type assembly the for |
| | preferred embodiment |
| 33 | guitar neck |
| 35 | guitar fret |
| 37 | guitar stings |
| 39 | preferred embodiment for the dial-a- |
| | chord |

### DETAILED DESCRIPTION OF THE PREFERRED EMBODIMENT

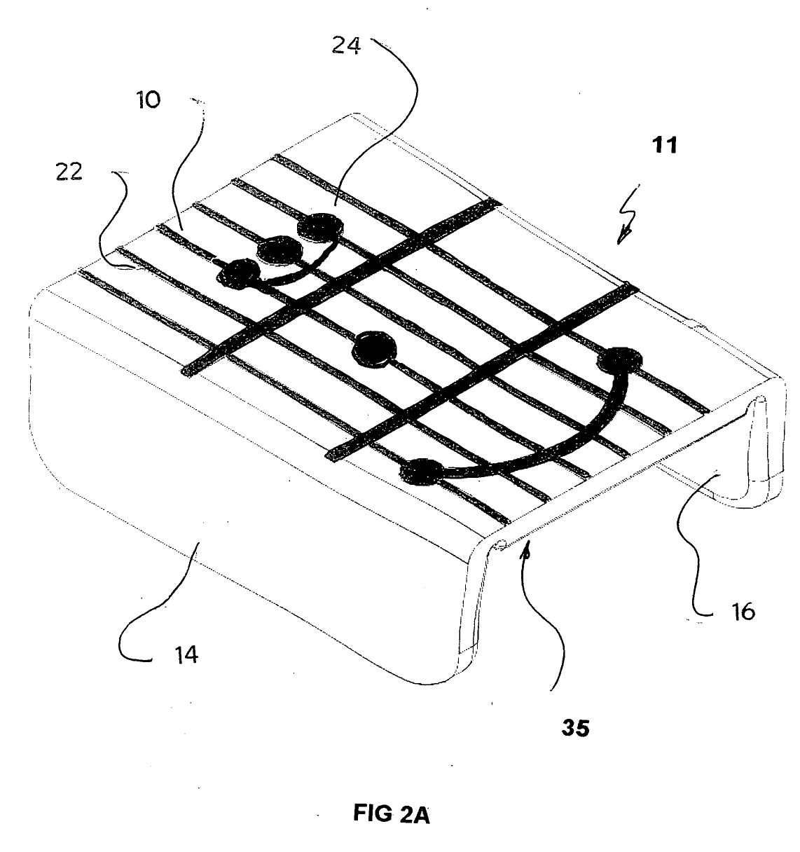

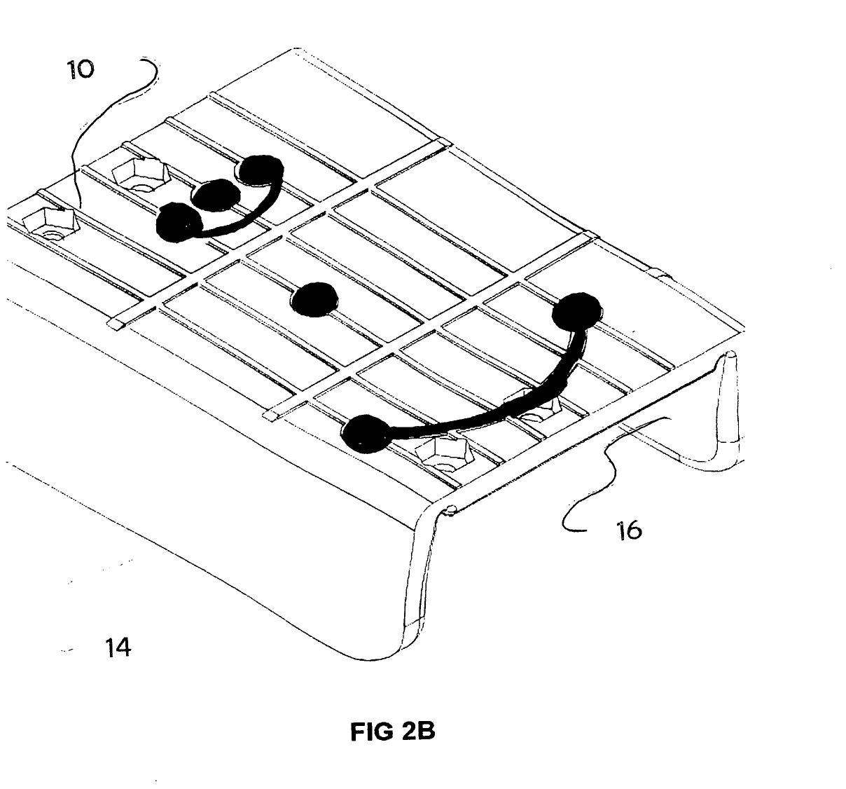

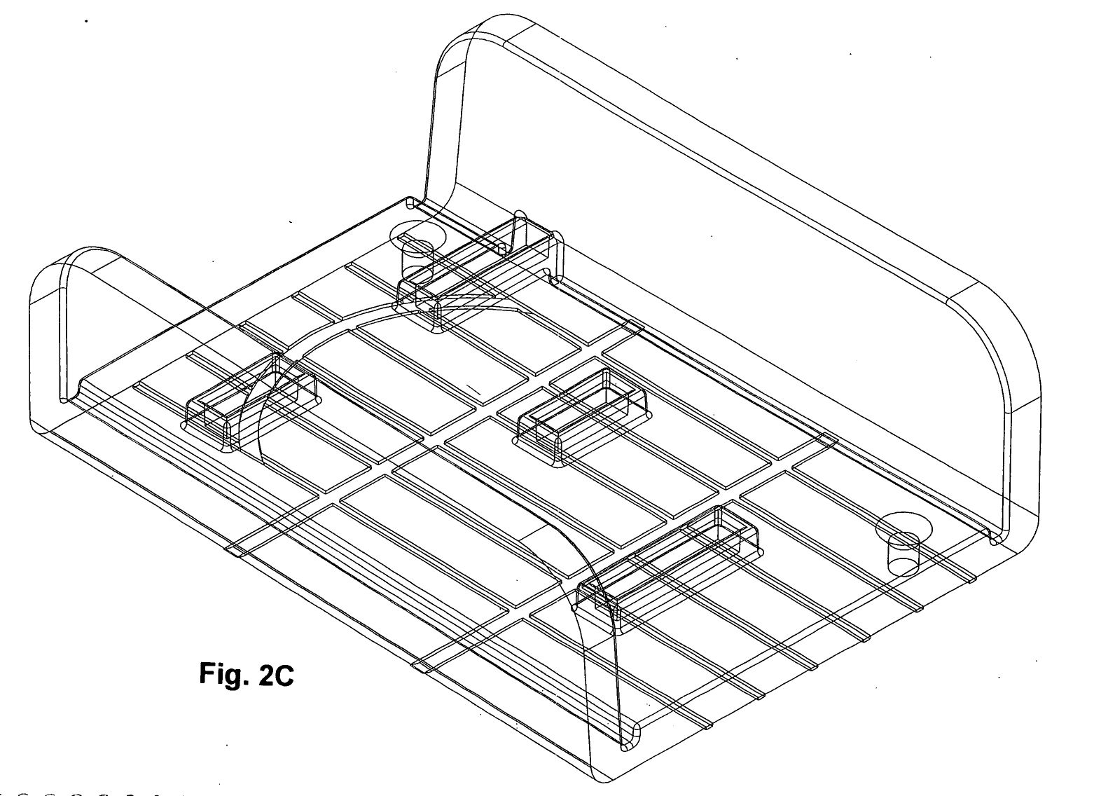

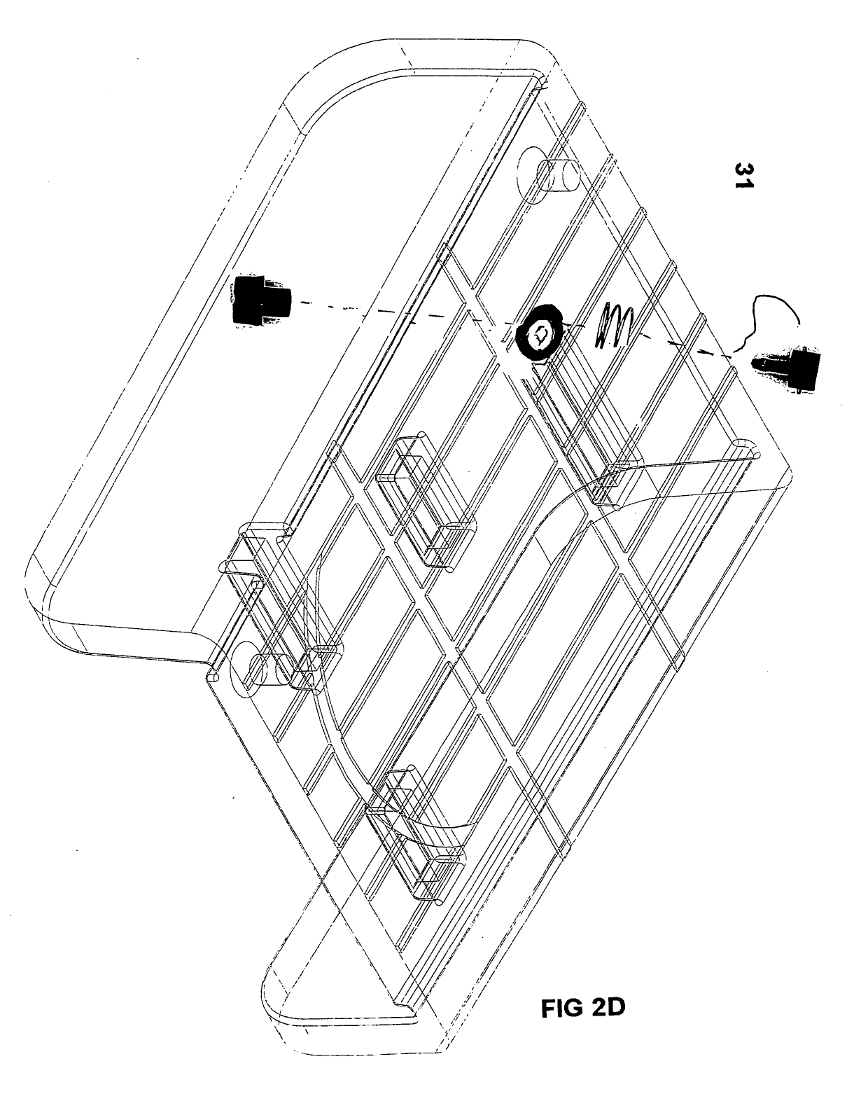

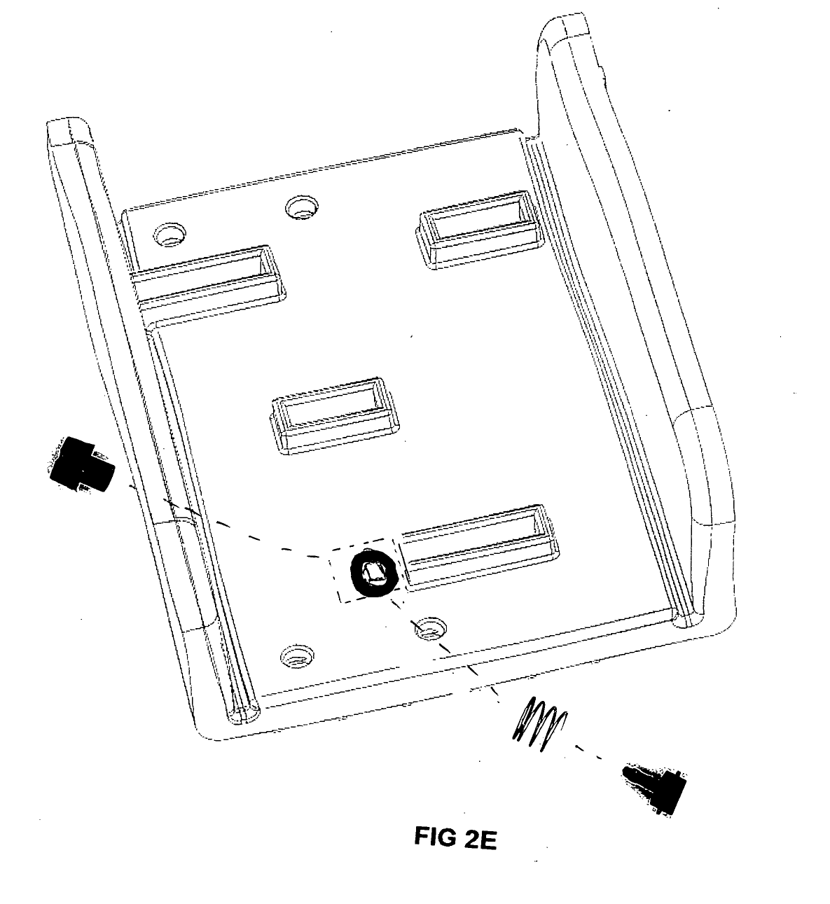

Referring now to the drawings, the preferred embodiment of the present invention provide a dial-a-chord fixed key plunger type mechanism, FIG. 2B (outside front and side view) formal drawing of the said dial-a-chord fixed key plunger type mechanism, FIG. 2C (outside front and side view) formal drawing of the said dial-chord fixed key plunger type (dissected) mechanism, FIG. 2D “three dimensional (3d) x-ray view) formal drawing of the said dial-a-chord fixed key plunger type (dissected) mechanism, FIG. 2E (inside back and side view) formal drawing of the said dial-a-chord fixed key plunger type (dissected) mechanism.

Referring in conjunction with FIG. 4a, an additional embodiment for the present invention is shown in an (outside front and side view formal (design) drawing of the said dial-a-chord (multiple) fixed key mechanisms.

### Operation—FIGS. 3A to 3F

To operate the said preferred embodiment fixed key plunger type guitar chord apparatus, the user may dial any chord within the desired said chord scale. Much the same as the said referred embodiment of the said pioneer invention the Guitar Playing Assist Apparatus, when utilized in concert with the said fixed key plunger type guitar chord apparatus, a wider range of multiple guitar chords are generated, for example; To change chords (FIG. 3A) from the barre-E multi-chord barre-chord position to the (FIG. 3B) barre-A multi-chord barre-chord position, the said chord apparatus is vertically moved downward to, and whereby the said fixed key plunger type mechanism is positioned over the B number 2 string. Whereby depressing the said plunger down to make contact with the said string onto the said fret, the said (FIG. 3A) barre-E-multi-chord-barre-chord is changed to the said (FIG. 3B) barre-A multi-chord barre-chord. Whereby depressing the said fixed key plunger in the said positions named above, additional multiple guitar chords are generated but not limited to the (high and low) A major, (high and low) B major, (high and low) C major, (high and low) D major, (high and low) E major and (high and low) F major.

To play the said (FIG. 3C) B major with the said present preferred embodiment, place the said chord apparatus front pads on the 2^{nd} fret and ensure the upper angle is firmly and evenly placed flush on the top or upper side of the said guitar neck, and to which the said plunger is positioned over the said B number 2 string. Whereby holding the said guitar chord apparatus evenly against the said strings in the said B minor position, whereby depressing the said plunger down to make contact with the said string, the said B minor becomes the said B major.

To play the said (FIG. 3D) C major with the said present preferred embodiment, place the said chord apparatus front pads on the 3^{rd} fret and ensure the said upper angle is firmly and evenly placed flush on the said top or upper side of the said guitar neck, and to which the said plunger is positioned over the said B number 2 string. Whereby holding the said chord device evenly against the said strings in the C minor position, whereby depressing the said plunger down to make contact with the said string, the said C minor becomes the said C major.

To play the said (FIG. 3E) D major with the said present preferred embodiment, place the said chord apparatus front pads on the 5^{th} fret and ensure the said upper angle is firmly and evenly placed flush on the said top or upper side of the said guitar neck, and to which the said plunger is positioned over the said B number 2 string. Whereby holding the said chord apparatus evenly against the said strings in the D minor position, whereby depressing the said plunger down to make contact with the said string, the said D minor becomes the said D major.

To play the said (FIG. 3F) E major with the said present preferred embodiment, place the said chord apparatus front pads on the 7^{th} fret and ensure the said upper angle is firmly and evenly placed flush on the said top or upper side of the said guitar neck, and to which the said plunger is positioned over the B number 2 string. Whereby holding the chord evenly against the strings in the E minor position, whereby depressing the said plunger down to make contact with the said string, the said E minor becomes the said E major.

As with the said pioneer preferred embodiment, and with the said present preferred embodiment disclosed on this said RPA, a said plurality or multiple chords are generated from the 0 fret to the 10^{th} fret. As with the said added fixed key plunger type chord apparatus, and in concert with the said pioneer invention, the following guitar chords groups are generated but not limited to the said E major, A minor and the said A major open guitar chords on the 0 fret; Also, the following guitar chords F major, B flat minor and B flat major on the 1^{st} fret; Also, G flat, F sharp, B minor and B major on the 2^{nd} fret; Also; G major, C minor and C major on the 3^{rd} fret; Also, A flat, G sharp, D flat minor and D flat major on the 4^{th} fret; Also, A major, D minor and D major on the 5^{th} fret; Also, B flat, A sharp, E flat minor and E flat major on the 6^{th} fret; Also, B major, E minor and E major on the 7^{th} fret; Also, C major, F minor and F major on the 8^{th} fret; Also, C sharp, G flat major and G flat minor on the 9^{th} fret. Also, D major, G minor and G major on the 10^{th} fret.

In addition to the guitar chords named above, the said invention also plays all of the power chords on the rudimentary scale respectively; Also, with the power chord/blues chord attachment, the said invention can produce a plurality/multiple (FIG. 4A) suspension chords or fixed key plunger type; Also, the said invention, with the fixed key plunger will generate multiple suspension chords.

Accordingly, the reader should see that like the preferred, additional and alternate embodiments, the dial-a-chord can be used by mentally, physically and visually handicapped people easily and conveniently to play or learn to play the guitar. In addition the dial-a-chord can be used by the public in general to learn and play the dozens of guitar chords in a timely and much simplified fashion. The quality of sound combined with fixed key plunger type mechanism for the chord apparatus far exceeds the conventional method of reading books and studying charts to learn to play the guitar. The advantage of the dial-a-chord to certain handicapped people is an advantage in a sense that there is no common or general knowledge of any device which is made for the physically impaired, amputee, people with joint disease, or mentally impaired people, and/ or sight impaired people to play or learn to play the guitar. Although the description above contains many specifications, these should not be construed as limiting the scope of the invention but as merely providing illustrations of some of the presently preferred and additional embodiments of this invention, thus, the scope of the said invention should be determined by the appended claims and their legal equivalents, in addition to the examples given.

1. (canceled)

2. A device for assisting a user in generating a chord on a guitar, said device comprising:
a clear and a plastic body having a set of matched strings laminated on its outward face sized and set apart to actual scale, said body is a generally planar body having an upper end generally parallel to a lower end and an inner surface parallel to an outer surface, said planar body is formed of a generally rigid material and said key pads are formed of a generally resilient material means to engage the guitar strings mounted to said guitar underneath said inner surface, wherein said means to engage said guitar strings comprises at least one key pad mounted to and extending from said inner surface, said at least one key pad is positioned opposite a chord indicia on said body and is adapted to press said guitar string on the finger board in the same manner as a human finger tip;
a neck guide affixed along the entire length of said upper end and extending laterally inward, wherein said neck guide and said gripping base generally provide lateral tracking about the neck of said guitar for guiding said planar body smoothly along said strings of said guitar;
a gripping base affixed along the entire length of said lower end and extending laterally inward;
wherein a plurality of said key pads are provided on and positioned to said inner surface of said body in a manner that can be slideably adjusted such as to mechanically impinge said guitar strings to generate said a selected chord when positioned selectedly and fingers are placed on said chord indicia positioned on said outside surface of said body opposite each one of said key pads, said chord indicia mark the proper placement of said fingers, and said key pads are formed of a generally resilient material; and
a chord indicia on said outer surface, wherein said chord indicia corresponds to the guitar chord generated, wherein said chord indicia comprises tactile guides on said outer surface that are raised or depressed to provide a means to easily identify said proper placement of said fingers.

3. The device for assisting a user in generating a chord on a guitar of claim 2, wherein said chord comprises tactile guides on said outer surface that are raised.

4. The device for assisting a user in generating a chord on a guitar of claim 2, wherein said chord comprises tactile guides on said outer surface that are depressed in the form of indentations, protrusions or finger holes.

5. The device for assisting a user in generating a chord on a guitar of claim 2, wherein said chord comprises tactile guides on said outer surface further comprise a fixed key plunger type mechanisms to provide a means to easily identify said proper placement of said fingers to press onto said fret and neck of said guitar to generate a plurality of/or multiple guitar chords as well as open guitar chords.
